(19) United States
(12) Patent Application Publication
(10) Pub. No.: US 2024/0110078 A1
(43) Pub. Date: Apr. 4, 2024

(54) WATER-BASED ACRYLIC ISOCYANATE COMPOSITIONS

(71) Applicant: Hawk Research Laboratories, LLC, Wheeling, IL (US)

(72) Inventors: Arron Strepka, Wheeling, IL (US); Makarand Joshi, Wheeling, IL (US)

(73) Assignee: Hawk Research Laboratories, Wheeling, IL (US)

(21) Appl. No.: 18/370,723

(22) Filed: Sep. 20, 2023

Related U.S. Application Data
(60) Provisional application No. 63/410,500, filed on Sep. 27, 2022.

(51) Int. Cl. C09D 133/14; C09D 175/04

(52) U.S. Cl. CPC C09D 133/14; C09D 175/04

(57) ABSTRACT

Coating compositions are provided that include water-dispersible acrylic polyol resin. The coating compositions may be applied to a surface such as acrylic, polyester, ceramic, metal, porcelain, glass, and vitreous china. The coating compositions have a viscosity of about 500 mPas or less, a VOC level of about 150 grams per liter VOCs or less, a pot life of about 180 minutes or less, and a cure time of about 48 hours or less after application to a substrate to form a dry film thickness of about 1 to about 6 mils. The coating compositions provide a coating having a hardness of about 2B to 5H as defined by ASTM D3363.

This application claims the benefit of U.S. Provisional Application No. 63/410,500, filed Sep. 27, 2022, which is incorporated in its entirety herein by reference.

Coating compositions are provided that include water-dispersible acrylic polyol resins that may be applied to a surface such as acrylic, polyester, ceramic, metal, porcelain, glass, and vitreous china. More specifically, the coating composition includes a water-dispersible acrylic polyol resin; a surface tension reducing agent; a diluent; and an aliphatic polyisocyanate crosslinker.

### BACKGROUND

Refinishing smooth surfaces, such as acrylic, polyester, ceramics metal, porcelain, glass, and vitreous china is often difficult. Typically, surfaces like ceramics are replaced or covered up rather than being refinished. Replacement and cover-up procedures are expensive and can require several days or weeks to complete.

Water dispersible acrylic polyol resins have been reacted with polyisocyanates to form coatings. However, the coatings may have unacceptable viscosities, high VOC levels, unacceptable open time/pot life times, and cure times. When applying two-component resin coatings directly to substrates like ceramic, adhesion is generally rather weak and adhesion failures are frequently observed. Further, multiple layers, including a primer layer and/or adhesion promoter, need to be applied. The resulting coatings may not provide a coating with desirable hardness.

### SUMMARY

Coating compositions are provided that include water-dispersible acrylic polyol resin. The coating compositions may be applied to a surface such as acrylic, polyester, ceramic, metal, porcelain, glass, and vitreous china. The coating compositions have a viscosity of about 500 mPas or less, a VOC level of about 150 grams per liter VOCs or less, a pot life of about 180 minutes or less, and a cure time of about 48 hours or less after application to a substrate to form a dry film thickness of about 1 to about 6 mils. The coating compositions provide a coating having a hardness of about 2B to 5H as defined by ASTM D3363.

A coating composition includes a water-dispersible acrylic polyol resin; a surface tension reducing agent; a diluent; and an aliphatic polyisocyanate crosslinker. The coating composition is provided as a two-part coating composition that includes a first part A having a water-dispersible acrylic polyol resin, a diluent and a surface tension reducing agent, and a second pan B that includes an aliphatic polyisocyanate crosslinker.

In another aspect, a process for coating a surface includes preparing a surface for mechanical adhesion; applying an adhesion promoter and/or primer; and applying a two-part coating composition that includes a first part A having a water-dispersible acrylic polyol resin, a diluent, and a surface tension reducing agent, and a second part B that includes an aliphatic polyisocyanate crosslinker. The coating may be applied to surfaces that include acrylic, polyester, ceramic, metal, porcelain, glass, vitreous china, and mixtures thereof.

### DETAILED DESCRIPTION

The following description is not to be taken in a limiting sense but is made merely for the purpose of describing the general principles of exemplary embodiments. The scope of the invention should be determined with reference to the claims.

### Coating Composition and Properties

In one aspect, the composition is provided as a two-part coating composition that includes a first part A having a water-dispersible acrylic polyol resin, and diluent, and surface tension reducing agent, and a second part B that includes an aliphatic polyisocyanate crosslinker. The coating composition is prepared by blending part A and part B in a ratio of about 1:1 to about 12:1 by volume, in another aspect, about 1:1 to about 1:11, in another aspect, about 1:1 to about 1:10, in another aspect, about 1:1 to about 1:9, in another aspect, about 1:1 to about 1:8, in another aspect, about 1:1 to about 1:7, in another aspect, about 1:1 to about 1:6, in another aspect, about 1:1 to about 1:5, in another aspect, about 1:1 to about 1:4, in another aspect, about 1:1 to about 1:3, in another aspect, about 1:1 to about 1:2, in another aspect, about 1:2 to about 1:12, in another aspect, about 1:2 to about 1:11, in another aspect, about 1:3 to about 1:10, in another aspect, about 1:4 to about 1:9, in another aspect, about 1:5 to about 1:8, in another aspect about 1:6 to about 1:7 and in another aspect, about 1:1 to about 4:1.

The coating compositions described herein provide desirable viscosity levels, low VOC levels, good pot life properties, and fast cure times. In this aspect, the coating composition has a viscosity of about 500 mPas or less measured using a Brookfield Viscometer equipped with an RV spindle set, measured at 100 rpm. In another aspect, the composition has a viscosity of about 350 mPas or less, in another aspect, about 200 mPas or less, in another aspect, about 350 to about 500 mPas, and in another aspect, about 50 to about 150 mPas.

In another aspect, the coating composition described herein have a VOC level of about 150 grams per liter VOCs or less, in another aspect, about 100 grams per liter or less, in another aspect, about 50 to about 100 grams per liter, and in another aspect, about 0 to about 50 grams per liter (Defined by EPA method 24, ASTM D2369).

In another aspect, the coating composition described herein have a pot life of about 180 minutes or less, in another aspect, about 120 minutes or less, in another aspect, about 60 minutes or less, and in another aspect, about 15 to about 60 minutes.

Coating composition described herein have a cure time of about 48 hours or less after application to a substrate to form a dry film thickness of about 1 to about 6 mils, in another aspect, a cure time of about 24 hours or less, in another aspect, a cure time of about 1 to about 16 hours.

The coating compositions described herein provide a coating pencil hardness of about 2B to about 5H as defined by ASTM D3363, in another aspect, about 2H to about 4H.

### Water Dispersible Acrylic Polyol Resin

The coating compositions include an acrylic-based polymer resin. In this aspect, the resin is a water-dispersible acrylic polyol resin. The acrylic polyol resin may include between about 2% to about 17% OH, in another aspect, about 2% to about 15%, in another aspect, about 2% to about 10%, in another aspect, about 2% to about 5%, in another aspect, about 2% to about 5%, in another aspect, about 5% to about 15%, in another aspect, about 2% to about 10%, and in another aspect, between about 7% to about 12% OH.

In particular aspects, the acrylic polyol resin may have a hydroxy equivalent weight (HEW) of between about 100 to about 800, in another aspect, about 300 to about 800, in another aspect, about 300 to about 600, in another aspect, between about 400 to about 700, and in another aspect, between about 500 to about 600. In still other aspects, the acrylic polyol resin may have an acid value of between about 3 to about 14, in another aspect, about 3 to about 10, in another aspect, about 3 to about 8, and in another aspect about 3 to about 5.

The acrylic polyol resin may be provided as an emulsion comprising between about 10% to about 90% by weight solids, in another aspect, about 20% to about 80% by weight solids, in another aspect, about 30% to about 70% by weight solids, in another aspect, about 40% to about 60% by weight solids, in another aspect, about 10% to about 75% by weight solids, in another aspect, about 10% to about 50% by weight solids, in another aspect, about 10% to about 25% by weight solids, in another aspect, about 40% to about 50% by weight solids. The continuous phase of the emulsion predominantly may comprise water and minor amounts of an organic solvent such-as butyl glycol and solvent naphtha (e.g., Solvesso 100).

In certain aspect, the acrylic polyol resin may be present in the coating composition (In Part A) at a level of between about 5% to about 60% by weight solids, in another aspect, between about 10% to about 50% by weight solids, or between about 20% to about 40% by weight solids. In certain aspect, the acrylic polyol resin may be present in the applied coating composition (Part A+Part B) a level of between about 5% to about 60% by weight solids, in another aspect, between about 5% to about 50% by weight solids, between about 5% to about 40% by weight solids, or between about 10% to about 30% by weight solids. Exemplary acrylic polyol resins that may be used with the coatings described herein are Bayhydrol A145 from Covestro AG, Setaqua 6517 and Setaqua 6511 from Nuplex Resins.

### Surface Tension Reducing Agent

Surface tension reducing agents are provided to enhance the spreading of the composition over the surface of the substrate. Surface tension reducing agents also help to avoid cratering and the creation of “fish eyes”, and improve leveling to create a smoother more attractive appearance. In this aspect, the tension-reducing agent may include silicone-containing surface additives, polyethers, and mixtures thereof. In certain aspect, the surface tension reducing agent may be present in the coating composition at a level of between about 0.1% to about 1.4% by weight, in another aspect, between about 0.2% to about 1.3% by weight, and in another aspect, between about 0.3% to about 1.2% by weight. Exemplary surface tension reducing agents that may be used with the coating described herein are BYK 333 and BYK 348 available from BYK-Gardener GmbH.

### Diluent

The coating compositions include a diluent. In this aspect, the diluent has about 3 to about 20 carbons. The diluent may include hydrocarbons, alcohols, esters, glycol ethers, glycols, and mixtures thereof. In certain aspect, the diluent may be present in the coating composition at a level of between about 0.4% to about 10% by weight, in another aspect, between about 0.6% to about 5% by weight, and in another aspect, between about 0.8% to about 1.6% by weight. An appropriate diluent has a desirable balance of compatibility with the polymer and degree of permanence. It will improve the mobility of the polymer both by making it more flexible (lowering the Tg) and by providing a medium through which the polymer can interact with the crosslinker. This aids in the formation of a continuous film with a higher cross-link density. The use of an incompatible diluent can detract from performance creating a softer film that is more susceptible to chemical attack.

### Aliphatic Polyisocyanate Crosslinker

The coating composition further includes a crosslinking agent. Crosslinking agents useful in the composition include water-dispersible isocyanate compositions. In this aspect, the isocyanate compound in the water-dispersible isocyanate composition is a polyisocyanate compound having two or more isocyanate (NCO) groups. The polyisocyanate compound may be an aliphatic polyisocyanate.

In this aspect, the coating composition includes a polyisocyanate crosslinker with a solids content of about 10 to about 100% by weight, in another aspect, about 20 to about 100%, in another aspect, about 10 to about 90% by weight, in another aspect, about 20 to 80% by weight, and in another aspect, about 25 to 75% by weight (% of Part B of the composition). In another aspect, the polyisocyanate crosslinker has an NCO equivalent weight of about 100 to about 400, in another aspect, about 100 to about 300, and in another aspect, about 150 to about 250.

In certain aspect, the aliphatic polyisocyanate crosslinker may be present in the coating composition at a level of between about 5% to about 55% by weight, in another aspect, between about 10%, to about 35% by weight, in another aspect between about 15% to about 25% by weight. An exemplary aliphatic polyisocyanate crosslinker that may be used with the coatings described herein is Bayhydur Ultra 2655 from Covestro AG. Examples of suitable aliphatic polyisocyanates are 1,6-hexamethylene diisocyanate (HDI), 1-isocyanato-3-isocyanatomethyl-3,5,5-trimethyl-cyclohexane (IPDI), 4,4′-diisocyanato dicyclohexylmethane (H₁₂MDI), di-isocyanatomethyl-cyclohexane (ADI), isomers thereof, polymers thereof, or mixtures thereof. In one aspect, polyisocyanate compounds include HDI trimer, polymeric MDI, or mixtures thereof. “Polymeric MDI” herein refers to a mixture of diphenylmethane diisocyanate, and its oligomer of polymer. Suitable commercially available water-dispersible isocyanate composition include, for example, BAYHYDUR™ XP2655 hydrophilic aliphatic polyisocyanate based on hexamethylene diisocyanate available from Bayer Material Science AG.

### Reducer Composition

In or aspect, the coating composition which includes a water dispersible acrylic polyol resin; a surface tension reducing agent; a diluent; and an aliphatic polyisocyanate crosslinker may be blended with a reducer composition. In this aspect, the coating composition (Parts A and B together) is blended with the reducer composition at a ratio of about 1:1 to about 30:1. In this aspect, the reducer composition is a blend of carboxylate ester and a carbonate ester. In this aspect, the reducer composition may include about 99 to about 99.5 parts carboxylate ester and about 0.5 to about 1-part carbonate ester. Examples of carboxylate esters include methyl acetate, ethyl acetate, butyl acetate, propyl acetate, and mixtures thereof. Examples of carbonate esters include propylene carbonate, ethylene carbonate, dimethyl carbonate, diethyl carbonate and mixtures thereof. In another aspect, 100% water can be used as a reducer along with other blends of hydrophilic solvents

### Additional Components

In some aspect, the amount of additional materials or other materials may range from between about 10% to about 60% by volume of the composition.

Coloring Agents and Decorative Solids: Other compounds, such as coloring agents and decorative solids, can be added to the topcoat composition to enhance to the aesthetics of the finished coating. Coloring agents, such as pigments or dyes, are included at various levels to obtain a desired effect. Decorative solids could include such items as metal flakes, polymeric flakes, glitter, beads, or other materials that provide a decorative feature to the finished coatings. The decorative solids are also included in various amounts to obtain a desired effect to the finished article.

Pigments and Dyes: If it is desired that the acrylic resin have a color or hue, any conventional pigment or dye can be utilized in conventional amounts. Hence, any pigment known to the art and to the literature can be utilized as for example titanium dioxide, iron oxide, carbon black, and the like, as well as various dyes provided that they do not prevent the desired reactions. Also finding utility in these coatings are various types pigments common to the art which include but are not limited to titanium dioxide, graphite, carbon black, zinc oxide, chromium oxide, zinc chromate, strontium chromate, barium chromate, chromium oxide, zinc sulfide, yellow nickel titanium, yellow chromium titanium, red iron oxide, transparent red iron oxide, yellow iron oxides, transparent yellow oxide, black iron oxide, naphthol reds and browns, anthraquinones, dioxazine violet, isoindoline yellows, arylide yellow and oranges, ultramarine blue, phthalocyanine complexes, amaranth, quinacridones, halogenated thioindigo pigments, extender pigments such as magnesium silicate, aluminum silicate, calcium silicate, calcium carbonate, fumed silica, barium sulfate, Titanium dioxide pigments such as TiONA 595 are available from Cristal. Other titanium dioxide pigments are available from Huntsman and DuPont.

Deaerators: In some embodiments, the compositions further include a deaerator. An example of a deaerator is Tallicin 4040, available from Pflaumer Brothers. Another example of a deaerator is Tego 822, available from Evonik Operations GmbH, and BYK A 530, available from BYK-Gardener GmbH. Without wishing to be bound by any particular theory it is believed that the negative effects of the release of entrained air or the outgassing of CO₂ may be minimized when a deaerator is utilized, which would otherwise allow for the development of cratering or pinholes in the surface since CO₂ gas would otherwise be trapped in the film (if it cures too quickly). It is believed that by minimizing outgassing, a smoother surface may be maintained. Applicants believe that by maintaining a smoother surface, the longevity of the surface may be extended.

Waxes: In some embodiments, the compositions further comprise one or more waxes. Examples of suitable waxes include paraffin waxes, polyethylene-based waxes, polypropylene-based waxes, each available from BYK-Gardener GmbH. Without wishing to be bound by any particular theory, waxes may impart at least some “slipperiness” to the surface of the coating when markers are used on the surface, or when additives are present within the compositions to improve abrasion.

Fillers: Inert powdered fillers, such as clay, talc, powdered calcium carbonate, whiting, zinc oxide, barytes, basic magnesium carbonate, water insoluble soaps, blanc fixe, aluminate, hydrated alkali silico aluminate and litharge may be included. Normally the amount of filler may vary from a low of 5 parts to a high of 200 parts, for example being about 50 to 100 parts, per hundred parts of reactive hydrogen containing compound or compounds (e.g. polyols). The amount of tiller should be adjusted to yield a mixture having the desired color, hardness or resistance to flow. The exact amount is inversely related to density of the filler. Suitable tillers include silicate-containing minerals, such as antigorite, serpentine, hornblends, amphibiles, chrysotile, talc, mica, and kieselguhr; metal oxides such as kaolin, aluminum oxides, titanium oxides, and iron oxides; metal salts such as chalk and heavy spar (barium sulfate) inorganic pigments such as cadmium sulfide and zinc sulfide; and glass, and the like. Fillers may be used either individually or in admixture. The fillers may be added to the coatings in quantities totaling about 10 to about 40 percent by weight based on the total quantity of coating. The skilled artisan will appreciate that the quantity of fillers included within any composition is related to the oil absorption values of the filler and not the density. Indeed, if high oil absorbing pigments are included, the viscosity of the coating increases and can change the gloss level or smoothness. It is believed that fillers are used to reduce costs or give some other properties like better spacing of the titanium dioxide to improve hiding or weathering.

Auxiliary Agents: In addition to the tillers described above, other auxiliary agents and additives may optionally be used. Suitable auxiliary agents and additives may include, for example, additional catalysts for the polyisocyanate-polyaddition reaction, drying agents, flattening agents (gloss reduction), surface-active additives, anti-foaming agents, dyes. UV stabilizers, plasticizers, wetting agents, dispersing agents, moisture scavengers, drying agents and fungistatic, antimicrobials, antibacterials or bacteriostatic substances. In some embodiments, the compositions may comprise an anti-sag agent, e.g. Cabosil.

In some embodiments, nanoparticles may be added to the coating compositions. For example, nanoparticle size aluminum oxide may be added so as to provide additional abrasion resistance without, it is believed, not affecting the gloss of the cured composition.

### Process for Coating a Surface

A process for coating a surface includes preparing the surface for mechanical adhesion, applying an adhesions promoter and applying the coating compositions described herein. Surfaces that may be coated include acrylic polyester, ceramic, metal, porcelain, glass, vitreous china, and mixtures thereof.

Surface Preparation for Mechanical Adhesion: The surface being treated should be free of dirt, oils, debris, and other contaminants. The area should be substantially free of residual dust, particulates, or other construction debris floating in the air as they may adhere to the paint and create unwanted particles that would be detrimental. Any gaps or cracks in the surface may be filled with known compatible compounds such as putties and calks. The surface should be wiped clean with water and/or other suitable solvents. In this aspect, a surface may be prepared for mechanical adhesion by abrading with abrasive material.

After cleaning and preparation of the surface, the surface is contacted with an acid selected from the group consisting of organic acids, inorganic acids, and mixtures thereof. In this aspect, organic acids are selected from the group consisting of citric acid, propionic acid, acetic acid, lactic acid, tartaric acid, maleic acid, oxalic acid, succinic acid, and mixtures thereof. Inorganic acids are selected from the group consisting of hydrofluoric acid, muriatic acid, phosphoric acid, nitric acid, and mixtures thereof. Acids may be contacted with the surface by any known methods, such as for example, wiping, rolling, and spraying. In some aspect, acids may be applied as a paste or gel. Some examples of acid based paste include hydrofluoric acid based paste such as Pore-Etch 1000 and Porc-Etch 1010 (Hawk Research Labs). In this aspect, the paste is applied as a thin film and allowed to dry, followed by washing the surface to remove the acids.

Application of Adhesion Promoter: An adhesion promoter is applied to the surface after it has been prepared for mechanical adhesion. Adhesion promoters are bifunctional materials that increase adhesive strength between the coating and the substrate. In this aspect, adhesion promoters are selected from the group consisting of a silane-based adhesion promoter, an acrylic-based adhesion promoter, a urethane-based adhesion promoter, an epoxy-based adhesion promoter, titanates, zirconates, phosphate esters, and mixtures thereof.

Adhesion promoters are applied using known methods such as spraying, wiping, brushing, and rolling. In this aspect, the adhesion promoter is applied to a thickness of about 1 mil or less, and in another aspect, about 1 to about 3 mils. The adhesion promoter is allowed to dry for about 5 to about 30 minutes before applying a topcoat.

Application of the Coating Composition: The coating compositions described herein may be applied over the adhesion promoter layer without the need for any primer layer, however, in certain aspects a primer may be utilized. As used herein, primer is defined as an undercoat is a preparatory coating put on materials before painting. Priming ensures better adhesion of paint to the surface, increases paint durability, and provides additional protection for the material being painted.

The compositions described herein may be used by any commercial painting contractor and lends itself to home and other do-it-yourself applications. The application of the coating composition to the substrate to be coated takes place with the methods known and customary in coatings technology, such as spraying, knife coating, curtain coating, vacuum coating, rolling, painting, pouring, dipping, spin coating, squeegeeing, brushing or squirting or by means of printing techniques such as screen, gravure, flexographic or offset printing and also by means of transfer methods. The coating composition can be applied using conventional spray equipment or high volume low pressure spray equipment resulting in a high quality finish. Other modes of application are sprinkling, flow coating, dipping, electrostatic spraying, or electrophoresis. In one aspect, the coating composition is applied using a brush, rollers, spray equipment, and combinations thereof.

In general, the coating can be formed by applying a solution that can have a sufficient viscosity such that the applied coating does not run soon after it is applied or during its curing. At the same time, the solution viscosity should be sufficient to permit easy application. For example, in some aspects, the applied solution can have a viscosity at 25° C. of 500 mPas or less.

The coating can be painted in a single coat or multiple coats using a roller, spray painted, brush painted or using other types of applicators or application methods such as described above. In this aspect, the topcoat composition may be applied to a dry film thickness of about 1 to about 6 mils.

The components of the compositions can be varied to suit the temperature tolerance of the substrate material. For example, the components can be constituted for air drying (e.g. less than 100° F.), low temperature cure (e.g. 100° F. to 180° F.), or high temperature cure (e.g. over 180° F.). The coatings may be formulated to meet the requirements of the equipment intended for use during application.

In some aspect, once the compositions are applied to a substrate they are allowed to cure at ambient temperatures. In some embodiments, the compositions are “tack free” in about one to three hours after application, e.g. such that the paint may be out of dust quicker than competitive products. In some embodiments, the compositions cure to a “dry hard” level in about 1 to about 48 hours, depending upon the thickness of the applied film.

Coatings with Abrasion Resistant Additives

In one aspect, the composition includes an abrasion resistant additive. The coating composition is blended with abrasion resistant additives at a ratio of about 99:1 to about 85:15.

The abrasion resistant additive may include synthetic fiber, a thermoplastic polymer that includes carbonate groups, ceramics, and mixtures thereof. In one aspect, the synthetic fiber may include Kevlar and mixtures thereof. In another aspect, the thermoplastic polymer is selected from the group consisting of polycarbonate, and mixtures thereof.

In some aspects, the abrasion resistant additive is in the form of a particle. In this aspect, the abrasions resistant particle will have a particle size effective for providing abrasion resistance and which are still of a size that can be applied with spraying.

### Example

Set forth below is a representative formulation. The formulation may be applied by spraying using HVLP equipment and roll using an ordinary roller.

| Pt. A | Pounds |
|---|---|
| Water | 182.18 |
| Borcigel 0625 | 8.00 |
| BYK 333 | 3.20 |
| BYK 028 | 2.24 |
| Setaqua 6517 (45% NVM) | 630.47 |
| BYK 348 | 3.20 |
| Catalyst | 1.59 |
| Tego 822 | 6.75 |
| SUBTOTAL | 837.63 |

| Pt. B | Pounds |
|---|---|
| Bahydor XP2655 | 333.59 |
| Acetone | 401.55 |
| SUBTOTAL | 735.14 |

The catalyst is a Dibutyl tin dilaurate (DBTDL)-based solution in acetone and xylene. The Formulation is 1 part Pt.A and one part Pt.B. The composition provides 3 to 1 NCO:OH.

While the invention herein disclosed has been described by means of specific embodiments, examples and applications thereof, numerous modifications and variations could be made thereto by those skilled in the art without departing from the scope of the invention set forth in the claims.

What is claimed is:

1. A coating composition comprising:
a water dispersible acrylic polyol resin;
a surface tension reducing agent;
a diluent; and
an aliphatic polyisocyanate crosslinker.

2. The coating composition of claim 1 wherein the coating is provided as a two-part coating composition that includes a first part A having a water dispersible acrylic polyol resin, a diluent and a surface tension reducing agent, and a second part B that includes an aliphatic polyisocyanate crosslinker.

3. The coating composition of claim 2 wherein part A and part B are blended at a ratio of about 1:1 to about 12:1 by volume.

4. The coating composition of claim 2 wherein the coating composition has a viscosity of about 500 mPas or less.

5. The coating composition of claim 2 wherein the coating composition has about 150 grams per liter VOCs or less.

6. The coating composition of claim 2 wherein the coating composition has a pot life of about 180 minutes or less and a cure time of about 48 hours or less after application to a substrate to form a dry film thickness of about 1 to about 6 mils.

7. The coating composition of claim 2 wherein the coating composition provides a coating having a coating pencil hardness of about 2B to about 5H as defined by ASTM D3363.

8. The coating composition of claim 1 wherein the water dispersible acrylic polyol resin includes an acrylic polyol resin having about 2 to about 17% OH.

9. The coating composition of claim 1 wherein the water-dispersible acrylic polyol resin includes an acrylic polyol resin having a hydroxy equivalent weight of about 100 to about 800.

10. The coating composition of claim 1 wherein the water-dispersible acrylic polyol resin includes an acrylic polyol resin having an acid value between about 3 to about 14.

11. The coating composition of claim 1 wherein the water-dispersible acrylic polyol resin has a solids content of about 10 to about 90 weight %.

12. The coating composition of claim 1 wherein the coating composition includes about 5% to about 60% by weight acrylic polyol resin.

13. The coating composition of claim 1 wherein the surface tension reducing agent is selected from the group consisting of silicone-containing surface additives, polyethers and mixtures thereof.

14. The coating composition of claim 1 wherein the coating composition includes about 0.1% to about 1.4% by weight surface tension reducing agent.

15. The coating composition of claim 1 wherein the diluent has about 3 to about 20 carbons.

16. The coating composition of claim 1 wherein the diluent is selected from the group consisting of hydrocarbons, alcohols, esters, glycol ethers, glycols, and mixtures thereof.

17. The coating composition of claim 1 wherein the coating composition includes about 0.4% to about 10% by weight diluent.

18. The coating composition of claim 1 wherein the polyisocyanate crosslinker has a solids content of about 20 to about 100 by weight %.

19. The coating composition of claim 1 wherein the polyisocyanate crosslink has an NCO equivalent weight of 100 to 400.

20. The coating composition of claim 1 wherein the coating composition includes about 0.4% about 10% by weight diluent.

21. The coating composition of claim 1 further comprising a reducer composition, wherein the reducer composition is blended with the coating composition at a ratio of about 3:1 to about 5:1.

22. The coating composition of claim 21 wherein the reducer composition is a blend of a carboxylate ester and a carbonate ester.

23. The coating composition of claim 22 wherein the carboxylate ester is selected from the group consisting of methyl acetate, ethyl acetate, butyl acetate, propyl acetate and mixtures thereof.

24. The coating composition of claim 22 wherein the carbonate ester is selected from the group consisting of propylene carbonate, ethylene carbonate, dimethyl carbonate, diethyl carbonate and mixtures thereof.

25. A process for coating a surface comprising:
preparing a surface for mechanical adhesion;
applying an adhesion promoter; and
applying a two-part coating composition that includes a first part A having a water-dispersible acrylic polyol resin, a diluent, and a surface tension reducing agent, and a second part B that includes an aliphatic polyisocyanate crosslinker.

26. The process of claim 25 wherein the surface is selected from the group consisting of acrylic, polyester, ceramic, metal, porcelain, glass, vitreous china, and mixtures thereof.

27. The process of claim 25 wherein the surface is prepared for mechanical adhesion by contacting the surface with an acid selected from the group consisting of organic acids, inorganic acids, and mixtures thereof.

28. The process of claim 25 wherein the surface is prepared for mechanical adhesion by abrading with abrasive media.

29. The process of claim 27 wherein the organic acids are selected from the group consisting of citric acid, propionic acid, acetic acid, lactic acid, tartaric acid, maleic acid, oxalic acid, succinic acid, and mixtures thereof.

30. The process of claim 27 wherein the inorganic acids are selected from the group consisting of hydrofluoric acid, muriatic acid, phosphoric acid, nitric acid, and mixtures thereof.

31. The process of claim 25 wherein the adhesion promoter is selected from the group consisting of a silane-based adhesion promoter, an acrylic-based adhesion promoter, a urethane-based adhesion promoter, an epoxy-based adhesion promoter, titanates, zirconates, phosphate esters, and mixtures thereof.

32. The process of claim 25 wherein the coating composition has a viscosity of about 500 mPas or less.

33. The process of claim 25 wherein the coating composition has about 150 grams per liter VOCs or less.

34. The process of claim 25 wherein the coating composition has a pot life of about 180 minutes or less and a cure time of about 48 hours or less after application to a substrate to form a dry film thickness of about 1 to about 6 mils.

35. The process of claim 25 wherein the coating composition provides a coating having a hardness of 2B to 5H as defined by ASTM D3363.

36. The process of claim 25 wherein the coating composition is applied using a brush, rollers, spray equipment, and combinations thereof.

37. The process of claim 25 further comprising a reducer composition, wherein the reducer composition is blended with the coating composition at a ratio of about 3:1 to about 5:1.

38. The process of claim 37 wherein the reducer composition is a blend of a carboxylate ester and a carbonate ester.

39. The process of claim 38 wherein the carboxylate ester is selected from the group consisting of methyl acetate, ethyl acetate, butyl acetate, propyl acetate and mixtures thereof.

40. The process of claim 38 wherein the carbonate ester is selected from the group consisting of propylene carbonate, ethylene carbonate, dimethyl carbonate, diethyl carbonate and mixtures thereof.
